(19) United States
(12) Patent Application Publication
(10) Pub. No.: US 2008/0255736 A1
(43) Pub. Date: Oct. 16, 2008

(54) GEO-REFERENCED AGRICULTURAL LEVEES

(75) Inventors: Lawrence Brian Braswell, Senatobia, MS (US); Brian Stone Peyton, Hollandale, MS (US); Jonathon Fortner, Oxford, MS (US); Steve J. Seaman, Oakland, TN (US); Brian Farriel Montgomery, Philipp, MS (US)

Correspondence Address: Connolly Bove Lodge & Hutz LLP, 1007 North Orange Street, P.O. Box 2207, Wilmington, DE, 19899-2207, US

(73) Assignee: HELENA HOLDING COMPANY, Wilmington, DE (US)

(21) Appl. No.: 12/100,755

(22) Filed: Apr. 10, 2008

Related U.S. Application Data
(60) Provisional application No. 60/910,946, filed on Apr. 10, 2007.

(51) Int. Cl. A01B 69/04; G06F 19/00

(52) U.S. Cl. 701/50

(57) ABSTRACT

A method of constructing levees used for management of water for the purpose of growing agricultural or horticultural crops, consisting essentially of:

Obtaining data from prior placement of water holding levees and using that data to replace the levees in essentially the same location as before.

### RELATED APPLICATIONS

This application claims benefit to U.S. 60/910,946 filed Apr. 10, 2007, which is incorporated by reference in its entirety.

### BACKGROUND OF THE INVENTION

The basis for farming involves flooding the fields to inhibit weed infestations and promote a uniform, high yielding rice crop. Traditionally this has been accomplished by surveying each field each year to determine the appropriate location for levees according to field topography. This method of surveying is performed using specialized laser equipment by individuals with specialized training to perform the service. This is a costly operation that must be performed each year by the farmer or by a third party.

In today's farming culture, accurate GPS systems are implemented for a variety of purposes, including implement guidance, auto steering, and site specific chemical applications. U.S. Pat. No. 6,880,643 (Zimmerman, et. al.) describes a land- leveling system that uses the Global Positioning System is provided. The system provides for an earth-moving machine mounted with an antenna that receives GPS signals from the satellites of the Global Positioning System. The earth-moving machine comprises a vehicle attached to a work implement, which is also connected to an actuator. A decision unit mounted on the vehicle sends control signals to the actuator, which controls the elevation of the work implement. These control signals are generated using the signals received from the antenna and the desired grade map. This system has an increased coverage area, more accuracy and round-the-clock operability. The system could be used to carry out all the land-leveling operations viz. surveying, leveling and verifying.

U.S. Pat. No. 6,434,462 (Bevly, et. al.) describes a control system for a work vehicle towing a towed implement, the vehicle having a steering system including steering actuator for steering steerable wheels in response to a steering control signal, the control system comprising: a steering angle sensor for generating a steering angle signal representing an angular position of the steerable wheels; an implement position generating unit generating actual implement position data; an desired implement position generating unit generating a desired implement position signal; a vehicle position generating unit generating vehicle position data; a processor unit generating an implement angle signal as a function of the actual implement position data and the vehicle position data; and a control processor generating the steering control signal as a function of the actual implement position data, the vehicle position data, the implement angle signal, the steering angle signal and the desired implement position signal, the steering actuator receiving the steering control signal and steering the steerable wheels in response thereto.

U.S. Pat. No. 5,955,973 (Anderson) describes a location system is used in a vehicle moving within an area at a selected speed and in a selected direction. A heading sensor provides a heading signal representing the direction of movement of the vehicle. A speed sensor provides a speed signal based on available reference signals representing the speed of the vehicle. A storage device stores the initial position data representing a selected initial position of the vehicle and checkpoint data representing a navigation checkpoint location. A database stores a plurality of records which each include geographic information data representing selective aspects of the area. A processor estimates a current position signal representing an estimated current position of the vehicle based on values of the heading signal, values of the speed signal, the initial position signal, and on previous values of the current position signal. Values of the current position signal correspond to records stored in the data base. A correction device selectively corrects the current position signal based on selected position inputs which indicate an approximate vehicle position relative to the navigation checkpoint location. An alerting device obtains an alerting signal indicating that the vehicle has reached a selected region within the area based on the current position signal and the geographic information data.

U.S. Pat. No. 5,438,817 (Nakamura) describes an outdoor working automating system includes a rice reaper having a position detecting unit for detecting a position by receiving radio waves from a GPS satellite and a control unit for controlling the position of the rice reaper so that the position traces predetermined route data, and a rice transplanter having a position detecting unit for detecting a position by receiving radio waves from the GPS satellite and a memory for storing the detected position. The outdoor working automating system causes the memory to store a route that the rice transplanter takes during rice transplanting, and causes the rice reaper to perform rice reaping automatically by using the position data stored in the memory as the route data of the rice reaper.

U.S. Pat. No. 5,606,850 (Nakamura) describes an outdoor working automating system includes a rice reaper having a position detecting unit for detecting a position by receiving radio waves from a GPS satellite and a control unit for controlling the position of the rice reaper sa that the position traces predetermined route data, and a rice transplanter having a position detecting unit for detecting a position by receiving radio waves from the GPS satellite and a memory for storing the detected position. The outdoor working automating system causes the memory to store a route that the rice transplanter takes during rice transplanting, and causes the rice reaper to perform rice reaping automatically by using the position data stored in the memory as the route data of the rice reaper.

Modem rice cultivation in the United States generally requires the use of a levee system. The document written by Bruce Beck “Missouri Rice Tillage Systems Compared” published 1994 and reviewed in 1998 can be found on the web at http://agebb.missouri.edu/rice/ricetill.htm. This document describes the normal process of constructing levees. This is a process requiring two operations. First, the field is surveyed using a tractor and laser leveling device. Once the pre-existing slope of the field is determined, software can be employed to map out the proper placement of levees. Levees will normally allow a 2/10 of a foot drop between contours.

Rice is not the only agricultural cropping system that employs the use of levees to control water flow. Levees can successfully be used in almost any crop, including, but not limited to:

Cotton,

Soybean,

Vegetables,

Fruit or

Corn.

### SUMMARY OF THE INVENTION

A present invention relates to method of constructing levees used for management of water for the purpose of growing agricultural or horticultural crops, consisting essentially of:
a. Obtaining data from prior placement of water holding levees and
b. Using that data to replace the levees in essentially the same location as before.

### BRIEF DESCRIPTION OF THE FIGURES

FIG. 1 illustrates 2005 NAIP Imagery of rice field exhibiting exact geography of levees.

FIG. 2 illustrates in time image classified into 7 zones. Notice levees are classified into class 1 or 2.

FIG. 3: illustrates geographical shape file used to build levees year after year.

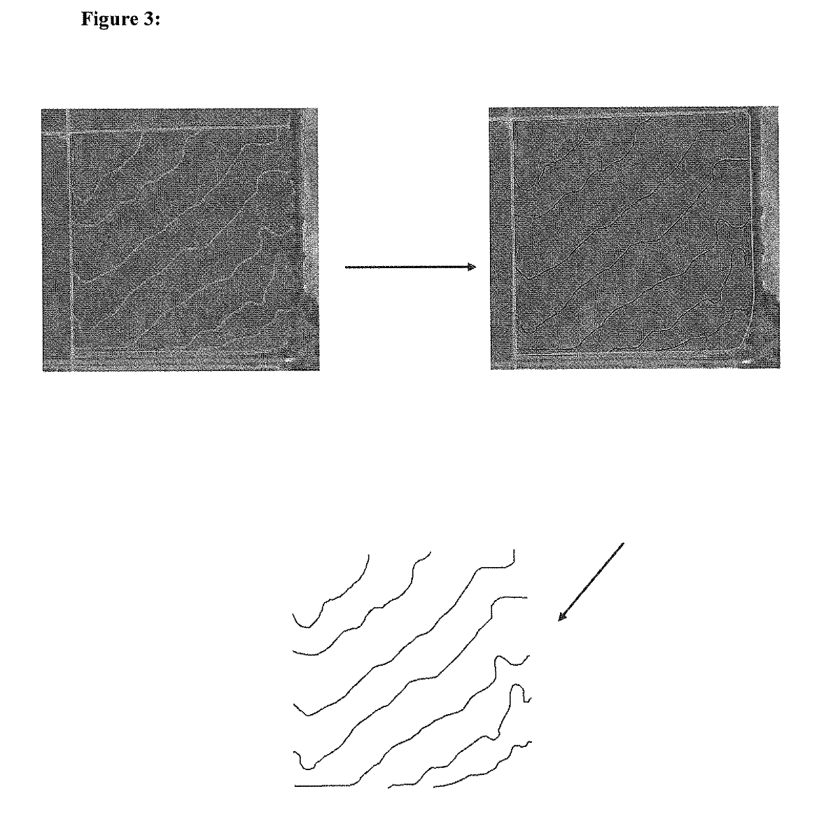

### A DETAILED DESCRIPTION OF THE INVENTION

As used herein, the singular terms “a” and “the” are synonymous and used interchangeably with “one or more.”

The present invention is a process requiring only one operation in the field to properly place and construct levees. The invention employs historical data on the placement of levees to simply replace the levees precisely where they were before. The historical data may be obtained from aerial imagery or from GPS data collected while the levees were built in prior years. The invention does not totally replace the need for proper placement of levees in the conventional laser guided manner. However, such placement is only required in the first year. Replacing those levees in subsequent years can be done with the present invention.

This technology can serve as the backbone to provide the agricultural industry with an innovative approach to building levees for flood irrigation. Using geo-referenced aerial imagery, specialized software and equipment, levees can be marked and used year after year post surveyed. Alternatively, prior year's levee locations can be identified by using a GPS unit. The GPS equipment can be but is not limited to a hand held, tractor mounted or survey grade GPS equipment.

All fields must have been surveyed and built at least once. The premise of this product is to use aerial imagery to identify the exact geographical location of the levees, use specialized software to automatically generate a guidance file that is read by an auto-steering system on a tractor to build the levees based on that information year after year.

Specialized Software The process to extract the precise geographical location of rice levees is achieved in two ways.

Method 1a: Geographical data collection from aerial image

There are two avenues to take with regard to imagery:

A. Public Data—An example of public data is the National Agricultural Imagery Program (NAIP). This program is distributed on a national scale and proceeds to collect color, 1-2 meter resolution imaged data for the country one time per year during the agricultural crop growing season. This data seems to be complete and of ample quality to be utilized for the levee product, especially rice.

B. Real Time Image Data—There will be circumstances where the public data is not clear, was not acquired, etc. In this case, a current aerial photo should be contracted for the information. Using Geographical Information System (“GIS”) software, geographical data is collected from aerial imagery of levee positions from prior years. Aerial imagery includes satellite imagery.

Using the GIS software the levees are manually “traced” by trained computer technicians. The data resulting is then processed to be compatible with tractor mounted auto steer system for tractor guidance for levee construction.

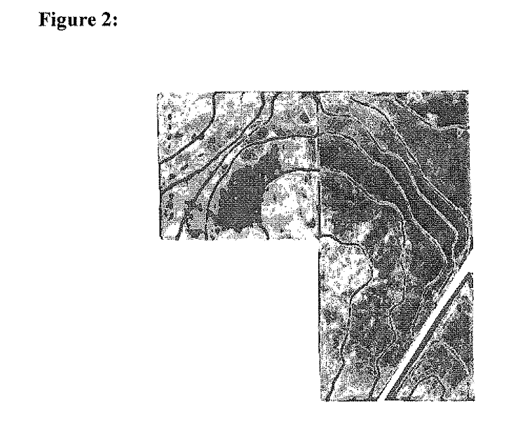

Another method according to the invention is aerial imagery is processed and classified to identify variation induced by levees present within field of interest (see FIG. 2). Classified imagery is processed to automatically “Trace” geographical location of levees using specialized filtering algorithms.

A further method according to the invention is geographical locations of levees are recorded using GPS equipment. The most common example of this method is to mark previous years levees using on-tractor GPS system. Data is stored and reused year after year.

Specialized Software—The process to extract the exact geographical locations of the levees should be an automated function of software. The steps that should be taken are:

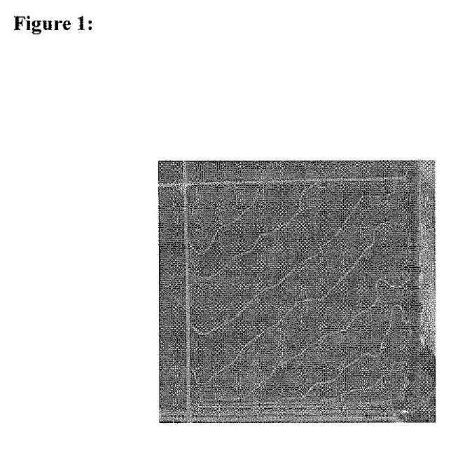

Classify the image to filter all attributes of the field except the levees (see FIG. 1)

Apply algorithm to create shape file for exact geography of levees. See FIG. 2.

The software converts shape file into an acceptable format. The format can be preferably accepted by branded tractor guidance system. There are many guidance systems used to automatically steer tractors as well as guide the tractor driver in making the correct turns. Current technology allows for pass to pass tracking. This method requires all guidance lines be parallel separated by the width of the implement being utilized. For the purpose of making rice levees, software must be developed to be integrated into a production guidance system to accept individual line geographies.

The end product is a file that can be loaded into farmers location or a commercial company's location, such as at a facility Helena Chemical Company location. The data can be then converted to the farmer's levee building tractor and/or simply go to the field with a levee plow and build levees in the proper locations based on this information. The process of surveying, marking, followed by building will be reduced to simply building the levees.

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described

We claim:

1. A method of constructing levees used for management of water for the purpose of growing agricultural or horticultural crops, consisting essentially of;
a. Obtaining data from prior placement of water holding levees and
b. Using that data to replace the levees in essentially the same location as before.

2. The method as claimed in claim 1, wherein a GPS system is used to obtain the data from the prior placement of holding levees.

3. The method as claimed in claim 2, wherein the GPS system is a hand held GPS, tractor mounted GPS system or a survey grade GPS equipment.

4. The method as claimed in claim 2, wherein the OPS system is a hand held GPS.

5. The method as claimed in claim 2, wherein the GPS system is a tractor mounted GPS system.

6. The method as claimed in claim 2, wherein the GPS system is a survey grade GPS equipment.

7. The method as claimed in claim 1, wherein the data from prior placement of water holding levees is obtained by using GPS equipment.

8. The method as claimed in claim 7, wherein the data from prior placement of water holding levees is obtained by marking previous years levees using on-tractor GPS system and storing the data and reusing the data year after year.

9. The method as claimed in claim 1, wherein the data from prior placement of water holding levees is obtained by aerial imagery and is processed and classified to identify variation induced by levees present within field of interest

10. The method as claimed in claim 9, wherein the classified imagery is processed to automatically trace geographical location of levees using specialized filtering algorithms.

11. The method as claimed in claim 1, wherein the data from prior placement of water holding levees is obtained by from aerial image and the data resulting is then processed to be compatible with tractor mounted auto steer system for tractor guidance for levee construction.
